(19) United States
(12) Patent Application Publication
(10) Pub. No.: US 2008/0218709 A1
(43) Pub. Date: Sep. 11, 2008

(54) Removal of deposition on an element of a lithographic apparatus

(75) Inventors: Roland Edward Van Vliet, Aalsmeer (NL); Harm-Jan Voorma, Kerkdriel (NL); Antonius Theodorus Wilhelmus Kempen, 's-Hertogenbosch (NL); Arjan Hovestad, 's-Hertogenbosch (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/714,905

(22) Filed: Mar. 7, 2007

(51) Int. Cl. G03B 27/52

(52) U.S. Cl. 355/30

(57) ABSTRACT

The invention provides a cleaning process for the removal of deposition on an element of a lithographic apparatus. The method includes (ex situ) treating the element with an alkaline cleaning liquid. In this way, Sn may be removed from a contaminant barrier or a collector mirror. Especially beneficial is the application of a voltages to the element to be cleaned and/or by using complexing agents for improving the dissolution of Sn in the cleaning liquid.

### BACKGROUND

1. Field

The present invention relates to a cleaning process for the removal of deposition on an element of a lithographic apparatus and especially relates to an ex situ cleaning process for the removal of deposition on the element.

2. Description of the Related Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of one or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include steppers, in which each target portion is irradiated by exposing an entire pattern onto the target portion at once, and scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

In a lithographic apparatus, the size of features that can be imaged onto the substrate is limited by the wavelength of the projection radiation. To produce integrated circuits with a higher density of devices, and hence higher operating speeds, it is desirable to be able to image smaller features. While most current lithographic projection apparatus employ ultraviolet light generated by mercury lamps or excimer lasers, it has been proposed to use shorter wavelength radiation, e.g. of around 13 nm. Such radiation is termed extreme ultraviolet (EUV) or soft x-ray, and possible sources include, for example, laser-produced plasma sources, discharge plasma sources, or synchrotron radiation from electron storage rings.

The source of EUV radiation is typically a plasma source, for example a laser-produced plasma or a discharge source. A common feature of any plasma source is the production of fast ions and atoms, which are expelled from the plasma in all directions. These particles can be damaging to the collector and condenser mirrors which are generally multilayer mirrors or grazing incidence mirrors, with fragile surfaces. This surface is gradually degraded due to the impact, or sputtering, of the particles expelled from the plasma and the lifetime of the mirrors is thus decreased. The sputtering effect is particularly problematic for the radiation collector. The purpose of this mirror is to collect radiation which is emitted in all directions by the plasma source and direct it towards other mirrors in the illumination system. The radiation collector is positioned very close to, and in line-of-sight with, the plasma source and therefore receives a large flux of fast particles from the plasma. Other mirrors in the system are generally damaged to a lesser degree by sputtering of particles expelled from the plasma since they may be shielded to some extent.

In the near future, extreme ultraviolet (EUV) sources will probably use tin (Sn) or another metal vapor to produce EUV radiation. This tin may leak into the lithographic apparatus, and will be deposited on mirrors in the lithographic apparatus, e.g. the mirrors of the radiation collector. The mirrors of such a radiation collector may have a EUV reflecting top layer of, for example, ruthenium (Ru). Deposition of more than approximately 10 nm tin (Sn) on the reflecting Ru layer will reflect EUV radiation in the same way as bulk Sn. It is envisaged that a layer of a few nm Sn is deposited very quickly near a Sn-based EUV source. The overall transmission of the collector will decrease significantly, since the reflection coefficient of tin is much lower than the reflection coefficient of ruthenium. In order to prevent debris from the source or secondary particles generated by this debris from depositing on the radiation collector, contaminant barriers may be used. Though such contaminant barriers or traps may remove part of the debris, still some debris will deposit on the radiation collector or other optical elements. Further, also deposition on these contaminant barriers or traps may take place.

### SUMMARY

It is desirable to provide a cleaning process, especially an ex-situ cleaning process, for the removal of deposition on an element of a lithographic apparatus, like a radiation collector of the lithographic apparatus or a contaminant barrier between the source and the radiation collector of the lithographic apparatus.

To that end, an embodiment of the invention provides a cleaning process for the removal of deposition on an element of a lithographic apparatus including treating the element with an alkaline cleaning liquid. The pH of the alkaline cleaning liquid may be in the range of about 8-15.

In an embodiment, the cleaning process is an ex situ process (i.e. outside the lithographic apparatus), wherein the process includes removing the element from the lithographic apparatus, treating the element with the alkaline cleaning liquid and rearranging the element after cleaning in the lithographic apparatus.

In an embodiment, the process includes submerging the element in the alkaline cleaning liquid. Submerging the element may be a partial or a complete submerging of the element. In a specific variant, the element is substantially completely submerged in the alkaline cleaning liquid. During the cleaning process, the cleaning liquid may be stirred or heated, or may both be stirred an heated. In an embodiment, the alkaline cleaning liquid has a temperature in the range of about 0-120° C., more especially in the range of about 20-90° C. The element to be cleaned may alternatively or additionally also be heated.

The element may be selected from the group consisting of a grating spectral filter, a transmissive optical filter, a multi-layer mirror, a grazing incidence collector, a normal incidence collector, a sensor, an optical sensor, a contaminant barrier, a patterning device (e.g. mask) and a construction element. With reference to the contaminant barrier, the contaminant barrier is in a specific embodiment a static contaminant barrier.

The deposition to be removed may especially include tin (Sn), for instance in view of the use of a Sn source as EUV source. Hence, the alkaline cleaning liquid is in an embodiment especially composed to etch away Sn from the element.

In a further embodiment, a voltage is applied to the element, wherein in a specific variant the voltage is in the range of about 0V-−1.2V vs. an Ag/AgCl reference electrode. Such process may especially be beneficial in removing tin from a contaminant barrier, especially a static contaminant barrier. In a specific variant, the voltage is in the range of about −0.7V-−1.0V, especially for elements having a surface including Mo, especially Mo surface surfaces such as of a contaminant barrier.

The element, such as the contaminant barrier, may have a first part that contains relatively more deposition than a second part, and the voltage applied to the element may have a gradient over the element. Especially then, the element may be arranged to have a larger voltage at the first part than at the second part. In an embodiment, the voltage at the first part is in the range of about −0.6V-−0.9V.

In yet a further embodiment, the cleaning liquid further includes a complexing agent, such as a gluconate, like sodium gluconate. The complexing agent is selected to complex (form a complex) with ionic contaminants, especially Sn ions.

In an embodiment of the cleaning process, the cleaning process includes treating the element with the alkaline cleaning liquid (as described herein), washing the cleaned element, drying the element and evaluating the element, optionally reintroducing the element in the cleaning process (depending upon the evaluation), and rearranging the element in the lithographic apparatus.

In an embodiment of the invention, there is provided a cleaning arrangement or system configured to clean the element, as described herein. To that end, an embodiment of the invention also provides a cleaning arrangement or system including a cleaning reactor, a washing reactor, a drying reactor and an evaluation system. The evaluation system may include a vacuum qualification evaluation system. Such cleaning arrangement or system is ex situ from the lithographic apparatus. In a specific embodiment, there is provided a combination of the lithographic apparatus and a cleaning arrangement (i.e. the lithographic apparatus and the cleaning reactor, the washing reactor, the drying reactor and the evaluation system). Some of the parts of the cleaning arrangement may be optional, for instance the evaluation system may be optional.

The lithographic apparatus, which may include elements to be cleaned after lithographic processing, and which may be used in the herein described combination of a cleaning arrangement or system and lithographic apparatus, includes, in an embodiment, an illumination system configured to condition a radiation beam; a support constructed to support a patterning device, the patterning device being capable of imparting the radiation beam with a pattern in its cross-section to form a patterned radiation beam; a substrate table constructed to hold a substrate; and a projection system configured to project the patterned radiation beam onto a target portion of the substrate. As described above, in a variant the lithographic apparatus is an EUV lithographic apparatus.

In an embodiment of the invention, there is provided a lithographic system including a lithographic apparatus including an illumination system configured to condition a radiation beam; a support constructed to support a patterning device, the patterning device being capable of imparting the radiation beam with a pattern in its cross-section to form a patterned radiation beam; substrate table constructed to hold a substrate; and a projection system configured to project the patterned radiation beam onto a target portion of the substrate; and a cleaning system including a cleaning reactor configured to treat an element of the lithographic apparatus with an alkaline cleaning liquid.

### BRIEF DESCRIPTION OF THE DRAWINGS

Embodiments of the present invention will now be described, by way of example only, with reference to the accompanying schematic drawings in which corresponding reference symbols indicate corresponding parts, and in which:

FIG. 1 schematically depicts a lithographic apparatus according to an embodiment of the present invention;

FIG. 2 schematically depicts a side view of an EUV illumination system and projection optics of a lithographic projection apparatus according to an embodiment of FIG. 1;

FIG. 3 schematically depicts a cross section through an embodiment of a source collector module;

FIG. 4 schematically depicts a cleaning system according to an embodiment of the invention;

FIG. 5 schematically depicts a cleaning system according to an embodiment of the invention; and

FIG. 6 shows cleaning results of collector cleaning processes according to embodiments of the process of the invention.

### DETAILED DESCRIPTION

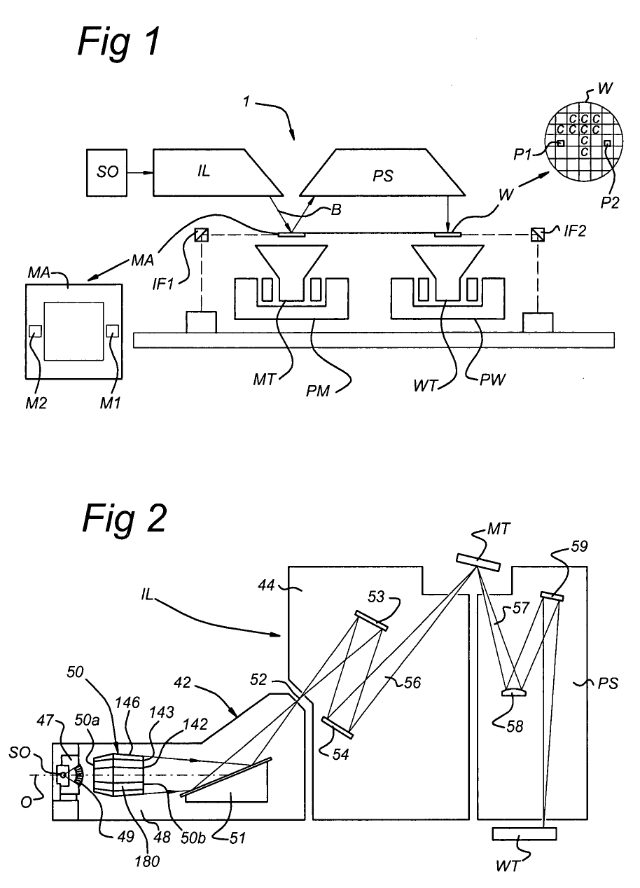

FIG. 1 schematically depicts a lithographic apparatus 1 according to an embodiment of the present invention. The apparatus 1 includes a source SO configured to generate radiation, an illumination system (illuminator) IL configured to condition a radiation beam B (e.g. UV radiation or EUV radiation) from the radiation received from source SO. The source SO may be provided as a separate unit. A support (e.g. a mask table) MT is configured to support a patterning device (e.g. a mask) MA and is connected to a first positioning device PM configured to accurately position the patterning device MA in accordance with certain parameters. A substrate table (e.g. a wafer table) WT is configured to hold a substrate (e.g. a resist-coated wafer) W and is connected to a second positioning device PW configured to accurately position the substrate W in accordance with certain parameters. A projection system (e.g. a refractive projection lens system) PS is configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The support supports, e.g. bears the weight of, the patterning device. It holds the patterning device in a manner that depends on the orientation of the patterning device, the design of the lithographic apparatus, and other conditions, such as for example whether or not the patterning device is held in a vacuum environment. The support can use mechanical, vacuum, electrostatic or other clamping techniques to hold the patterning device. The support may be a frame or a table, for example, which may be fixed or movable as required. The support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the patterning device (e.g. mask) and the projection system. Immersion techniques are well known in the art for increasing the numerical aperture of projection systems. The term “immersion” as used herein does not mean that a structure, such as a substrate, must be submerged in liquid, but rather only means that liquid is located, for example, between the projection system and the substrate during exposure.

Referring to FIG. 1, the illuminator IL receives radiation from a radiation source SO. The source and the lithographic apparatus may be separate entities, for example when the source is an excimer laser. In such cases, the source is not considered to form part of the lithographic apparatus and the radiation is passed from the source SO to the illuminator IL with the aid of a beam delivery system including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjusting device configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support (e.g., mask table) MT, and is patterned by the patterning device. After being reflected by the patterning device (e.g. mask) MA, the radiation beam B passes through the projection system PS, which projects the beam onto a target portion C of the substrate W. With the aid of the second positioning device PW and position sensor IF2 (e.g. an interferometric device, linear encoder or capacitive sensor), the substrate table WT can be moved accurately, e.g. so as to position different target portions C in the path of the radiation beam B. Similarly, the first positioning device PM and another position sensor IF1 (e.g. an interferometric device, linear encoder or capacitive sensor) can be used to accurately position the patterning device (e.g. mask) MA with respect to the path of the radiation beam B, e.g. after mechanical retrieval from a mask library, or during a scan. In general, movement of the support (e.g. mask table) MT may be realized with the aid of a long-stroke module (coarse positioning) and a short-stroke module (fine positioning), which form part of the first positioning device PM. Similarly, movement of the substrate table WT may be realized using a long-stroke module and a short-stroke module, which form part of the second positioning device PW. In the case of a stepper, as opposed to a scanner, the support (e.g. mask table) MT may be connected to a short-stroke actuator only, or may be fixed. Patterning device (e.g. mask) MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the mask alignment marks may be located between the dies.

The depicted apparatus could be used in at least one of the following modes:
a. In step mode, the support (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.
b. In scan mode, the support (e.g. mask table) MT and the substrate table WT are scanned synchronously while a pattern imparted to the radiation beam is projected onto a target portion C (i.e. a single dynamic exposure). The velocity and direction of the substrate table WT relative to the support (e.g. mask table) MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
c. In another mode, the support (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The term “lens”, where the context allows, may refer to any one or combination of various types of optical components, including refractive, reflective, magnetic, electromagnetic and electrostatic optical components.

The term “contaminant” refers to depositions such as Sn depositions, but also refers to undesired species that are physically or chemically adsorbed to surfaces of optical elements or other elements of the lithographic apparatus. Especially, the term “contaminant” refers to metal halides or metal oxides or metal oxyhalides.

The terms “radiation” and “beam” used herein encompass all types of electromagnetic radiation, including ultraviolet (UV) radiation (e.g. having a wavelength λ of 365, 248, 193, 157 or 126 nm) and extreme ultra-violet (EUV or soft X-ray) radiation (e.g. having a wavelength in the range of 5-20 nm, e.g. 13.5 nm), as well as particle beams, such as ion beams or electron beams. Generally, radiation having wavelengths between about 780-3000 nm (or larger) is considered IR radiation. UV refers to radiation with wavelengths of approximately 100-400 nm. Within lithography, it is usually also applied to the wavelengths which can be produced by a mercury discharge lamp: G-line 436 nm; H-line 405 nm; and/or I-line 365 nm. VUV is Vacuum UV (i.e. UV absorbed by air) and refers to wavelengths of approximately 100-200 nm. DUV is Deep UV, and is usually used in lithography for the wavelengths produced by excimer lasers like 126 nm-248 nm. The person skilled in the art understands that radiation having a wavelength in the range of, for example, 5-20 nm relates to radiation with a certain wavelength band, of which at least part is in the range of 5-20 nm.

FIG. 2 shows the projection apparatus 1 in more detail, including a radiation system 42, an illumination optics unit 44, and the projection system PS. The radiation system 42 includes the radiation source SO which may be formed by a discharge plasma. EUV radiation may be produced by a gas or vapor, for example Xe gas, Li vapor or Sn vapor in which a very hot plasma is created to emit radiation in the EUV range of the electromagnetic spectrum. The very hot plasma is created by causing an at least partially ionized plasma by, for example, an electrical discharge. Partial pressures of, for example, 10 Pa of Xe, Li, Sn vapor or any other suitable gas or vapor may be required for efficient generation of the radiation. In an embodiment, a Sn source as EUV source is applied. The radiation emitted by radiation source SO is passed from a source chamber 47 into a collector chamber 48 via an optional gas barrier or contaminant trap 49 (also indicated as contaminant barrier or foil trap) which is positioned in or behind an opening in source chamber 47. The contaminant trap 49 may include a channel structure. Contamination trap 49 may also include a gas barrier or a combination of a gas barrier and a channel structure. The contaminant trap or contaminant barrier 49 further indicated herein at least includes a channel structure, as known in the art.

The collector chamber 48 includes a radiation collector 50 which may be formed by a grazing incidence collector. Radiation collector 50 has an upstream radiation collector side 50a and a downstream radiation collector side 50b. Radiation passed by collector 50 can be reflected off a grating spectral filter 51 to be focused in a virtual source point 52 at an aperture in the collector chamber 48. From collector chamber 48, a beam of radiation 56 is reflected in illumination optics unit 44 via normal incidence reflectors 53, 54 onto a patterning device (e.g. reticle or mask) positioned on a support (e.g. reticle or mask table) MT. A patterned beam 57 is formed, which is imaged in projection system PS via reflective elements 58, 59 onto wafer stage or substrate table WT. More elements than shown may generally be present in illumination optics unit 44 and projection system PS. Grating spectral filter 51 may optionally be present, depending upon the type of lithographic apparatus. Further, there may be more mirrors present than those shown in the Figures, for example there may be 1-4 more reflective elements present than 58, 59. Radiation collectors 50 are known from the prior art.

Instead of a grazing incidence mirror as collector mirror 50, also a normal incidence collector may be applied. Collector mirror 50, as described herein in an embodiment in more detail as nested collector with reflectors 142, 143, and 146, and as schematically depicted in amongst others FIG. 2 is herein further used as example of a collector (or collector mirror). Hence, where applicable, collector mirror 50 as grazing incidence collector may also be interpreted as collector in general and in a specific embodiment also as normal incidence collector.

Further, instead of a grating 51, as schematically depicted in FIG. 2, also a transmissive optical filter may be applied. Optical filters transmissive for EUV and less transmissive for or even substantially absorbing UV radiation are known in the art. Hence, “grating spectral purity filter” is herein further indicated as “spectral purity filter” which includes gratings or transmissive filters. Not depicted in schematic FIG. 2, but also included as optional optical element may be EUV transmissive optical filters, for instance arranged upstream of collector mirror 50, or optical EUV transmissive filters in illumination unit 44 and/or projection system PS.

All optical elements shown in FIG. 2 (and optical elements not shown in the schematic drawing of this embodiment) are vulnerable to deposition of contaminants (for instance produced by source SO), for example, Sn. This is the case for the radiation collector 50 and, if present, the grating spectral filter 51. Hence, the cleaning method of an embodiment of the present invention may be applied to those optical elements, but also to normal incidence reflectors 53, 54 and reflective elements 58, 59 or other optical elements, for example additional mirrors, gratings, etc. In an embodiment, the optical element is selected from the group consisting of collector mirror 50, radiation system 42 (also known as source collector module), illumination system IL and projection system PS (also known as projection optics box POB). In an embodiment, the element may also be a spectral purity filter 51. Hence, in an embodiment, the optical element is selected from the group consisting of one or more optical elements contained that may be present in radiation system 42, like collector mirror 50 (be it a normal incidence collector or grazing incidence collector), spectral purity filter 51 (grating or transmissive filter), radiation system (optical) sensors (not depicted), optical elements contained in illumination system 44, like mirrors 53 and 54 (or other mirrors, if presents) and illumination system (optical) sensors (not depicted), optical elements contained in the projection system PS, like mirrors 58 and 59 (or other mirrors, if presents) and projection system (optical) sensors (not depicted). In yet another embodiment, the element may also be a patterning device (e.g. a mask) (for instance indicated in FIG. 1 as mask) MA, in particular a reflective multilayer mask. In a specific embodiment, the term “optical element” also includes contaminant barrier 49. Therefore, the term optical element refers to one or more elements selected from the group consisting of a grating spectral filter, a transmissive optical filter, a multi-layer mirror, a coating filter on a multi-layer mirror, a grazing incidence mirror, a normal incidence mirror (such as a multi-layer collector), a grazing incidence collector, a normal incidence collector, a(n) (optical) sensor (such as an EUV sensitive sensor), contaminant barrier 49, and a patterning device (e.g. mask).

Further, not only optical elements may be contaminated by deposition such as Sn or contaminated by other contaminations, etc., but also construction elements such as walls, holders, supporting systems, gas locks, and also contaminant barrier 49, etc. This deposition may not directly influence the optical properties of the optical elements, but due to redeposition, this deposition may deposit (i.e. redeposit) on optical elements, thereby influencing the optical properties. Hence, even deposition not deposited on optical elements may in a later stage due to redeposition lead to contamination of surfaces of optical elements. This may lead to a decrease in optical performance like reflection, transmission, uniformity, etc. Likewise, halogen molecules of metal halides may desorb and readsorb on surfaces of optical elements.

In an embodiment (see also above), radiation collector 50 may be a grazing incidence collector. The collector 50 is aligned along an optical axis O. The source SO or an image thereof is located on optical axis O. The radiation collector 50 may include reflectors 142, 143, 146 (also known as a Wolter-type reflector including several Wolter-type reflectors). Sometimes they are also called shells. These reflectors (or shells) 142, 143, 146 may be nested and rotationally symmetric about optical axis O. In FIG. 2 (as well as in other Figures), an inner reflector is indicated by reference number 142, an intermediate reflector is indicated by reference number 143, and an outer reflector is indicated by reference number 146. The radiation collector 50 encloses a certain volume, i.e. the volume within the outer reflector(s) 146. Usually, this volume within outer reflector(s) 146 is circumferentially closed, although small openings may be present. All the reflectors 142, 143 and 146 include surfaces of which at least part includes a reflective layer or a number of reflective layers. Hence, reflectors 142, 143 and 146 (more reflectors may be present and embodiments of radiation collectors (also called collector mirrors) 50 having more than 3 reflectors or shells are included herein), are at least partly designed for reflecting and collecting EUV radiation from source SO, and at least part of the reflector may not be designed to reflect and collect EUV radiation. For example, at least part of the back side of the reflectors may not be designed to reflect and collect EUV radiation. The latter part may also be called back side. On the surface of these reflective layers, there may in addition be a cap layer for protection or as optical filter provided on at least part of the surface of the reflective layers.

The radiation collector 50 is usually placed in the vicinity of the source SO or an image of the source SO. Each reflector 142, 143, 146 may include at least two adjacent reflecting surfaces, the reflecting surfaces further from the source SO being placed at smaller angles to the optical axis O than the reflecting surface that is closer to the source SO. In this way, a grazing incidence collector 50 is configured to generate a beam of (E)UV radiation propagating along the optical axis O. At least two reflectors may be placed substantially coaxially and extend substantially rotationally symmetric about the optical axis O. It should be appreciated that radiation collector 50 may have further features on the external surface of outer reflector 146 or further features around outer reflector 146, for example a protective holder, a heater, etc. Reference number 180 indicates a space between two reflectors, e.g. between reflectors 142 and 143. Each reflector 142, 143, 146 may include at least two adjacent reflecting surfaces, the reflecting surfaces further from the source SO being placed at smaller angles to the optical axis O than the reflecting surface that is closer to the source SO. In this way, a grazing incidence collector 50 is configured to generate a beam of (E)UV radiation propagating along the optical axis O. At least two reflectors may be placed substantially coaxially and extend substantially rotationally symmetric about the optical axis O. It should be appreciated that radiation collector 50 may have further features on the external surface of outer reflector 146 or further features around outer reflector 146, for example a protective holder, a heater, etc.

During use, on one or more of the outer 146 and inner 142/143 reflector(s), deposition may be found. The radiation collector 50 may be deteriorated by such deposition (deterioration by debris, e.g. ions, electrons, clusters, droplets, electrode corrosion from the source SO). Deposition of Sn, for example due to a Sn source, may, after a few mono-layers, be detrimental to reflection of the radiation collector 50 or other optical elements, which may necessitate the cleaning of such optical elements.

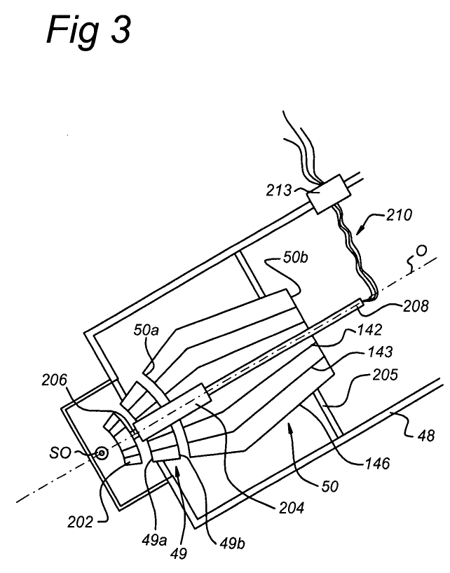

FIG. 3 shows an embodiment of a source collector module where the optical axis O intersects a horizontal plane (e.g. earth) under a predetermined angle as may the case in many practical situations. The contaminant barrier 49 is shown to have an upstream contaminant barrier side 49a and a downstream contaminant barrier side 49b. This contaminant barrier 49 is a static contaminant barrier. Such static contaminant barrier 49 is for instance described in U.S. Pat. No. 6,359,969 or in U.S. Ser. No. 11/527,728 (filed on Sep. 27, 2005), which are herein incorporated by reference.

The source collector module may include an additional, rotatable contaminant barrier 202. The rotatable contaminant barrier 202 is located upstream (i.e., closer to the source SO) than the contaminant barrier 49. The rotatable contaminant barrier 202 is rotatable by a motor 204 about optical axis O. The motor 204 is connected to the rotatable contaminant barrier 202 by a drive shaft 206. The motor 204 is located partly within an opening 63 in the contaminant barrier 49 and partly within the radiation collector 50. The radiation collector 50 is shown to be supported by the collector chamber 48 with a supporting structure 205, e.g. including a plurality of rods. Such rotatable contaminant barrier 202 is for instance described in US2006/0219958 or in U.S. patent application Ser. No. 11/235,547 (filed on Sep. 27, 2005) or in U.S. Ser. No. 11/527,728 (filed on Sep. 27, 2005), which are herein incorporated by reference.

In an embodiment, downstream the motor 204 is connected to a hollow shaft 208 that is extending along optical axis O in order to avoid blocking portions of the radiation generated by source SO as much as possible. The hollow shaft 208 accommodates a plurality of cables 210 configured to supply energy to motor 204, to input and output sensing signals to sensors (not shown), etc. The hollow shaft 208 may also accommodate one or more ducts configured to supply or drain any desired gas to or from the interior of the source collector module. The cables 210 are led to the exterior of the source collector module through a sealing ring 213. As will be clear to the person skilled in the art, other constructions are possible.

When one wishes to clean the radiation collector 50 ex-situ, i.e., at a location exterior to the collector chamber 48, one has to remove the radiation collector 50 from the collector chamber 48. Likewise, when one whishes to clean static contaminant barrier 49, or other elements of the lithographic apparatus (such as the rotatable contaminant barrier 202), the static contaminant barrier 49 and other elements, respectively, have to be removed from the lithographic apparatus. Removal may be performed with conventional systems or devices, although elements such as the collector 50 or the static contaminant barrier 49 may especially be constructed or may especially be arranged in constructions designed to be removed from the lithographic apparatus.

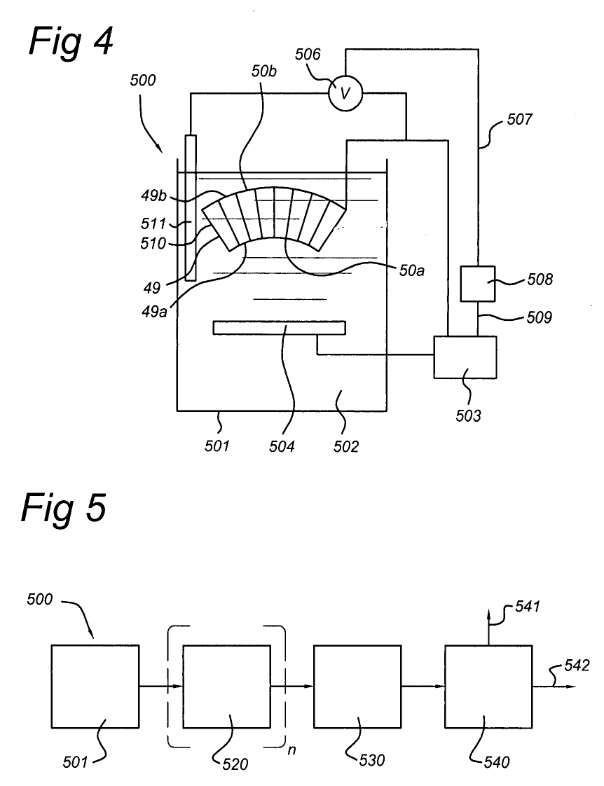

To this end, in an embodiment of the invention, there is provided a cleaning arrangement or system 500 and cleaning process as described herein. FIG. 4 schematically depicts a cleaning arrangement or system 500 (including optional elements), wherein by way of example an element 510 to be cleaned is the static contaminant barrier 49; however, also other elements 510 could have been drawn, such as the rotatable contaminant barrier 202 or a collector mirror 50. The element 510 is in this embodiment submerged in a alkaline cleaning liquid, indicated with reference 502. The alkaline cleaning liquid 502 is contained in cleaning reactor 501. In this way, an element 510 of a lithographic apparatus may be cleaned ex situ. Especially, the element 510 may be cleaned by submerging the element 510 (completely) in the alkaline cleaning liquid 502. The element 510 may be selected from the group consisting of a grating spectral filter, a transmissive optical filter, a multi-layer mirror, a grazing incidence collector, a normal incidence collector, a sensor, an optical sensor, a contaminant barrier, a patterning device (e.g. mask) and a construction element, and especially a collector 50 or a static contaminant barrier 49. The deposition for instance includes tin (Sn), which may effectively be removed by the cleaning liquid. The pH of the cleaning liquid 502 is especially in the range of about 8-15, such as about 14.5, and the temperature of the cleaning liquid 502 is especially in the range of about 0-120° C. The cleaning liquid 502 may be stirred, with systems or devices known in the art. Further, ultra sound may be applied to improve cleaning. The cleaning liquid 502 may be refreshed batch wise or continuously during the cleaning process of element 510. Further, the cleaning liquid 502 may be sparged with air, oxygen or another gas. Sparging the cleaning liquid 502 with oxygen may speed up the dissolution process of Sn. The cleaning liquid preferably includes water that is made alkaline by adding a base such as NaOH, KOH or other bases (or combination of bases). Hence, the cleaning liquid can be an alkaline cleaning solution.

The cleaning liquid may further includes a complexing agent, especially a cleaning agent selected to complex Sn ions. In this way removal of Sn may be enhanced and the cleaning liquid 502 may get saturated at relatively higher concentration. In an embodiment, the complexing agent includes a gluconate, such as sodium or potassium gluconate, but also other complexing agents may be applied. Other suitable complexing agents may be selected from the group consisting of citrate, tartrate, acetate, oxalate, maleate, proprionate, glyoxylate, and EDTA. Also combinations of complexing agents may be used, such as gluconate and oxalate, etc. The counter ions of the complexing agents (i.e. before adding to the cleaning liquid 502) are especially selected from the group consisting of sodium and potassium.

In a specific embodiment, the cleaning arrangement or system 500 may further include a system or device configured to generate a potential to the element 510 to be cleaned. For instance, the cleaning arrangement or system may further include a voltage source 503, arranged to apply a voltage between a reference, working or auxiliary electrode 504 (also in the cleaning liquid 502) and the element 510 to be cleaned. The counter electrode 504 is preferably an “inert” electrode, i.e. substantially inert under the conditions of the process. An example of such inert electrode is a passivated metal electrode, a noble metal electrode or a stainless steel electrode.

In a specific embodiment, the voltage applied to the element 510 to be cleaned is defined relative to a reference electrode 511. The voltages mentioned herein are applied relative to a Ag/AgCl reference electrode. As will be clear to the person skilled in the art, other reference electrodes may be used and the voltages may be adapted correspondingly. Using a reference electrode 511, the output voltage of the power source is regulated such that element 510 has the defined potential difference with the reference electrode 511. This set-up is chosen instead of a simple two electrode set-up with a constant voltage supplied by the power supply 503 (voltage source). In a two electrode set-up changes in the solution due to tin build-up and due to tin removal on the element 510 surface might lead to changes in the electrochemical processes and thereby in the tin dissolution (and molybdenum protection, in case Mo surfaces are present, such as in the case of Mo foils of a static contaminant barrier). In the three electrode set-up the dissolution rate (and molybdenum protection or protection of other surfaces, vide infra) may be maintained during the cleaning process.

In a specific embodiment of the cleaning process a voltage is applied to element 510 in the range of about 0V-−1.2V vs. an Ag/AgCl reference electrode 511. In yet another embodiment, the voltage is in the range of about −0.6V-−1.1V, especially about −0.7V-−1.0V.

Especially in the case of a contaminant barrier, such a static contaminant barrier 49, such process may be worthwhile, for at these voltages, Mo (but also Ni or Ru) is protected, whereas Sn dissolves. A more positive voltage may lead to attack on Mo, whereas a more negative voltage does not seem to improve the process considerably or may even hinder the cleaning process since dissolved tin may (re)deposit on the surfaces of the element 510. Hence, in a specific embodiment, the process is applied to clean elements having surfaces selected from the group consisting of Ni surfaces, Ru surfaces, Mo surfaces and stainless steel surfaces (including different surfaces, such as a Ru surface and a Mo surface). As mentioned above, such element 510 may be collector 50, which may in an embodiment have Ni shells with a Ru top coating, or may be a static foil trap 49 or a rotatable contaminant barrier 202, which may have Mo foils, or stainless steel parts like shutters, holders, etc. Especially suitable potential ranges for elements 510 with a Mo surface are in the range of about −0.6-−1.1V; especially suitable potential ranges for elements 510 with a Ru surface are in the range of about −0.2-1.0V; especially suitable potential ranges for elements 510 with a Ni surface are in the range of about 0-1.0V; and especially suitable potential ranges for elements 510 with a stainless steel surface are in the range of about 0-1.0V. The terms “Mo surface”, “Ru surface” and “Ni surface”, refer to surfaces having a metal layer as surface layer (such as a top coating) or refer to surfaces having a alloy including the metal as surface or to surfaces having a metal compound as surface layer. For instance, the term “Mo surface”, may refer to a surface of element 510 having a Mo-layer as surface layer, or a Mo alloy or a Mo carbide, etc. Specific surface materials for a contaminant barrier, such as rotatable contaminant barrier 202, are described in US2006/0219958, which is herein incorporated by reference. The terms “Mo surface”, “Ru surface” and “Ni surface”, especially refers to surfaces having a metal layer as surface layer (such as a top coating).

As will be clear to the person skilled in the art, when assuming a Sn source as source SO, parts of elements 510 arranged upstream will in generally be more contaminated with Sn than parts of such elements 510 arranged downstream. For instance, static contaminant barrier 49 has an upstream side 49a and a downstream side 49b. Likewise, collimator 50 has an upstream side 50a and a downstream side 50b, etc. In general, the contamination of a part closer to the upstream side of the element 510 will be more contaminated by Sn than a part closer to the downstream side of the element 510. Hence, the element 510 may have a first part that contains relatively more deposition than a second part. In a specific embodiment, as schematically depicted for a static contaminant barrier 49 in the schematic drawing of FIG. 4, the voltage applied to the element 510 has a gradient over the element 510 and the element 510 is arranged to have a larger voltage at the first part than at the second part. For instance, referring to FIG. 4, the part closer to the counter electrode 504 will in general have a more positive voltage, whereas the part farther away (close to the contact with the voltage source 503) in general will have a more negative voltage. Hence, in an embodiment, the element 510 is arranged in such a way in the cleaning arrangement or system 500, that the more contaminated part (first part) has a more positive potential than a less contaminated part (second part). In this way, the cleaning process can additionally be controlled. The voltage at the first part is in the range of about −0.6V-−0.9V.

In a specific embodiment, the cleaning arrangement or system 500 further includes a controller 508, arranged to receive an input signal from a voltmeter 506, for instance via a signal carrier 507, such as a dateline or wireless, and arranged to control the voltage source 503, for instance via a signal carrier 509, such as a data line or wireless. In this way, the voltage applied to the element 510 can be controlled to be in the above defined range. Controller 508 may further be arranged to control one or more processes and parameters selected from the group consisting of gas sparging cleaning liquid 502, agitating cleaning liquid 502, refreshing cleaning liquid 502, controlling the temperature of cleaning liquid 502, controlling the pH of cleaning liquid 502, controlling the concentration of a complexing agent in cleaning liquid 502, moving, removing and/or introducing the element 510 to be cleaned, etc.

In an embodiment, the controller 508 may include a memory, with executable instructions, an input-output unit, configured to (i) receive one or more input signals from one or more selected from the group consisting of (1) one or more sensors and (2) a user input device and (ii) send one or more output signals to control one or more of the processes and parameter defined above, respectively; and a processor designed to process the one or more input signals into one or more output signals based on the executable instructions. The sensors may be arranged to sense one or more parameters selected from the group consisting of the temperature of cleaning liquid 502, the pH of cleaning liquid 502, the concentration of the complexing agent in cleaning liquid 502, the position of the element 510 in the cleaning liquid 502 or elsewhere in the cleaning arrangement 500, and properties of the element 510 (such as reflectivity, outgassing, etc.) etc.

In a specific embodiment of the invention as shown in FIG. 5, the cleaning arrangement or system 500 includes cleaning reactor 501, as described above, including optional system or device configured to apply a voltage as described above, and further includes one or more (n; n is a natural number of 1 or higher) washing vessels 520, arranged to wash the element 510 after the cleaning process, thereby for instance removing remaining cleaning liquid from the element 510, a dryer 530, arranged to dry the cleaned and optionally washed element 510 with means known in the art such as hot air blower, IR dryers, etc, and optionally an evaluation system 540, arranged to measure (qualify) the element 510 on its suitability to return in the lithographic apparatus 1. For instance, the reflectivity of an optical element may be measured, but also outgassing, etc. may be measured in the evaluation system. The evaluation system 540 may for instance be a vacuum qualification system, configured to qualify the suitability of the cleaned element for application in the vacuum in the lithographic apparatus 1. For example, the evaluation system is configured to perform measurements on the dried element to determine whether the element is within pre-determined specification. Depending upon the outcome, the element 510 may be rerouted to a previous processing stage, which is indicated with reference number 541, or may be transferred to the lithographic apparatus, indicted with reference number 542.

In an embodiment of the invention (not depicted), there is provided a combination of a lithographic apparatus and the cleaning arrangement as described herein. The combination may be termed a “lithographic system”.

### EXAMPLES

### Example 1

### Cleaning of the Static Contaminant Barrier 49

A cleaning liquid was freshly prepared for each SCB cleaning (static contaminant barrier 49 cleaning): 10-20 g/l Potassium hydroxide (KOH) in demineralized-water. To prevent saturation of the solution with tin, the concentration should preferably be higher than about 10 g/l KOH. Solution saturation may not affect the static contaminant barrier 49, but may result in incomplete cleaning of the static contaminant barrier 49. The operation parameters for the process solution are the following: Room temperature: about 20-30° C.; voltage of about −1.0±0.1 V versus a Silver/Silver Chloride (Ag/AgCl) reference electrode (3M KCl) (standard Ag/AgCl reference electrode 511); continuous air sparging: about 15-25 l/minute; agitation by solution recirculation through bad recirculation: about 15-20 l/minute. The voltage is applied in a so-called three electrode set-up as schematically shown in FIG. 4. The static contaminant barrier 49 and a stainless steel plate (counter electrode 504) are connected to power source 503. Using a reference electrode 511, the output voltage of the power source is regulated such that the static contaminant barrier 49 has the defined potential difference with the reference electrode 511. This set-up was chosen instead of a simple two electrode set-up with a constant voltage supplied by the power supply. In the two electrode set-up changes in the solution due to tin build-up and on the static contaminant barrier 49 surface due to tin removal might lead to changes in the electrochemical processes and thereby tin dissolution and molybdenum protection (in this embodiment). In the three electrode set-up the dissolution rate and molybdenum protection is maintained during the process.

The application of a voltage is preferred. Absence of the voltage may lead to attack of molybdenum foils on the static contaminant barrier 49 in the order of about 50-100 nm per hour. Also a voltage more positive than about −0.6 V vs. Ag/AgCl may lead to attack on the molybdenum and an extremely low tin dissolution rate. A more negative voltage than about −1.1 V vs. Ag/AgCl is not detrimental to the molybdenum, but may reduce the tin dissolution rate. For these reasons a voltage of about ±100 mV around about −1.0 V is preferred. The air sparging and agitation can be applied to maintain an acceptable tin dissolution rate. In the absence of air sparging or agitation the tin dissolution rate may be low. Variations in air sparging and agitation may lead to variations in the tin dissolution rate.

In the table below the cleaning rate and the corresponding cleaning time are given for the voltage of about −1 V vs. Ag/AgCl and for about a 100 mV lower and higher voltage. These values were measured on samples of static contaminant barriers 49, on tin plated molybdenum foils and on tin foil in lab tests.

TABLE 1
Performance of static contaminant barrier 49 cleaning process

| Process Voltage | Cleaning rate | Cleaning time |
|---|---|---|
| V vs Ag/AgCl | μm/hour | Hours* |
| −1.1 V | 0.4–3 | 10–72 |
| −1 V | 0.8–8 | 4–36 |
| −0.9 V | 2–20 | 2–16 |

*Based on a mean tin thickness of 30 μm (400 g tin on static contaminant barrier 49)

As can be seen in the table at the specified voltage of −1 V vs. Ag/AgCl, the static contaminant barriers 49 with 400 g (30 μm) tin can is fully cleaned in maximum 36 hours. A change in voltage of 100 mV doubles or halves the cleaning time. Using a more positive voltage than −1 V to reduce cleaning time is not advised however. Due to the geometry of the static contaminant barriers 49 it can not be avoided that a voltage distribution is created over each individual foil. Parts of a foil closest to the stainless steel plate have a more positive potential and parts farthest away from the stainless steel plate have a more negative potential as the applied mean voltage (see FIG. 4). Consequently, using a more positive mean voltage than −1 V vs. Ag/AgCl could lead to molybdenum attack at parts closest to the stainless steel plate when about −0.5 V is exceeded. Similarly, at parts farthest from the stainless steel plate tin dissolution would be inhibited. An advantage of the voltage distribution is that the tin dissolution rate is not homogeneous over the foils. This voltage distribution is in line with the tin thickness distribution. Tin dissolution is fastest at areas where tin thickness is the largest and vice versa. Laboratory tests on the voltage distribution show that a factor of 2-5 increase in tin dissolution rate compared to the mean dissolution rate might be achieved. However, the actual of this effect has to be determined from cleaning real static contaminant barriers 49.

In this example, no complexing agent was added to the cleaning liquid.

### Example 2

### Cleaning of the Collector 50

Two solutions and three processes for cleaning the collector 50 are, by way of example, described herein. Process 1 is able to fully clean the collector 50, but also dissolves the bonding adhesive. In Process 2 and 3 tin could not be fully dissolved, but the bonding adhesive remains stable for at least 72 hours.

Process 1: The following process solution was freshly prepared for each collector cleaning: about 80-120 g/l Potassium hydroxide (KOH) in demineralized-water. The operation parameters for the process solution are the following: room temperature: about 20-30° C.; bath recirculation: about 5-10 l/minute.

Process 2: The following process solution was freshly prepared in demineralized water for each collector cleaning: about 0.05-0.15 g/l Potassium hydroxide (KOH) and about 100-120 g/l Sodium Gluconate (HOCH₂(CH(OH))₄CO₂Na). The operation parameters for the process solution are the following: pH 12; Room temperature: about 20-30° C.; bath recirculation: about 5-10 l/minute

Process 3: In process 3 the same solution is used as in process 2. After about 8-12 hours of cleaning the cleaning liquid is dumped and cleaning is continued a fresh solution of the same composition. The operating conditions are the same as in process 2.

In table 2 the cleaning times are given for the three processes for collector 50 cleaning. These values were obtained form collector 50 samples sputtered with 2.7 nm of tin. The tin thickness was analyzed with XRF assuming homogeneous coverage of the collector 50 surface with tin. The relative reflectivity is a theoretical calculation based on the measured tin thickness.

TABLE 2
Performance of collector cleaning processes

| | Cleaning time | Final tin thickness | |
|---|---|---|---|
| Process | Hours* | nm | Relative reflectance^{$} |
| 1 | 12 | <0.2 | >95% |
| 2 | 16 | 1.5 | 80% |
| 3 | 16 + 16 | 1.0 | 85% |

*Based on a mean tin thickness of 3 nm (theoretical relative reflectance of <70%)
^{$}Theoretical calculation based on tin thickness

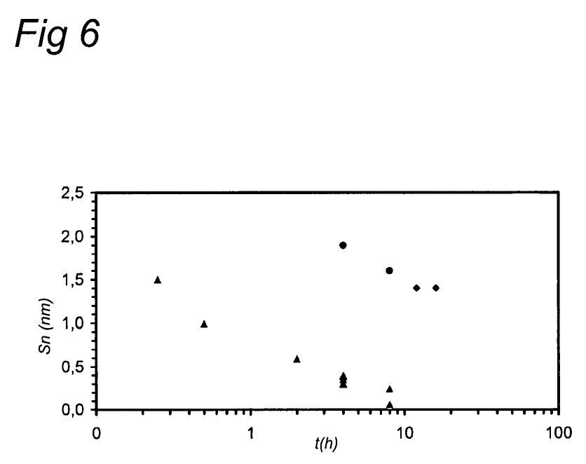

The cleaning rate is not constant in time, but decreases in time for all processes as shown in FIG. 6 (triangles: process 1; circles: process 2; cubes: process 3). For process 1, the tin thickness decrease in time can be described by the following third order polynomial:

$$d = {d}_{0} ( - {( \frac{t}{T} )}^{3} + 3 {( \frac{t}{T} )}^{2} - 3 ( \frac{t}{T} ) + 1 )$$

where d0 is the thickness before cleaning (2.7 nm), t is the cleaning time and T is the time to complete tin removal (12 hours). This behavior can be explained assuming that tin is present as hemispherical clusters on the collector surface. Tin dissolution reduces the radius of the cluster and thereby the tin surface area available for further dissolution. As the dissolution speed is surface area dependent this gives a reduction in the tin dissolution rate averaged over the entire collector surface.

The dissolution behavior of Process 2 can not be described by the above relation. Initially the trend is similar to process 1 with a factor of 5 lower dissolution rate. After about 8 hours the tin dissolution rate strongly decreases to less than about 0.005 nm/hour. The cause of this decrease in tin dissolution is not fully understood. The data for process 3 show that it might be partly due to saturation of the solution by tin. Using a fresh solution after cleaning 8 and 72 hours gives an additional tin dissolution 0.2-0.5 nm in 4-24 hours.

Although specific reference may be made in this text to the use of lithographic apparatus in the manufacture of ICs, it should be appreciated that the lithographic apparatus described herein may have other applications, such as the manufacture of integrated optical systems, guidance and detection patterns for magnetic domain memories, flat-panel displays, flat panel displays including liquid-crystal displays (LCDs), thin-film magnetic heads, etc. It should be appreciated that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

While specific embodiments of the present invention have been described above, it should be appreciated that the present invention may be practiced otherwise than as described. For example, the present invention may take the form of a computer program containing one or more sequences of machine-readable instructions describing a method as disclosed above, or a data storage medium (e.g. semiconductor memory, magnetic or optical disk) having such a computer program stored therein. This computer program may be used to control the removal of the deposition, control the pressures, etc.

The descriptions above are intended to be illustrative, not limiting. Thus, it will be apparent to one skilled in the art that modifications may be made to the present invention as described without departing from the scope of the claims set out below.

The present invention is not limited to application of the lithographic apparatus or use in the lithographic apparatus as described in the embodiments. Further, the drawings usually only include the elements and features that are necessary to understand the present invention. Beyond that, the drawings of the lithographic apparatus are schematic and not on scale. The present invention is not limited to those elements, shown in the schematic drawings (e.g. the number of mirrors drawn in the schematic drawings). Further, the present invention is not confined to the lithographic apparatus described in relation to FIGS. 1 and 2 or the specific construction depicted in FIG. 3. The present invention described with respect to a radiation collector may also be employed to (other) multilayer, grazing incidence mirrors or other optical elements. It should be appreciated that embodiments described above may be combined.

What is claimed is:

1. A cleaning process for the removal of deposition on an element of a lithographic apparatus comprising treating the element with an alkaline cleaning liquid.

2. The cleaning process according to claim 1, wherein the process is an ex situ process and wherein the process comprises removing the element from the lithographic apparatus, treating the element with the alkaline cleaning liquid and rearranging the element after cleaning in the lithographic apparatus.

3. The cleaning process according to claim 1, wherein the process comprises submerging the element in the alkaline cleaning liquid.

4. The cleaning process according to claim 1, wherein the element is selected from the group consisting of a grating spectral filter, a transmissive optical filter, a multi-layer mirror, a grazing incidence collector, a normal incidence collector, a sensor, an optical sensor, a contaminant barrier, a patterning device and a construction element.

5. The cleaning process according to claim 1, wherein the deposition comprises tin (Sn).

6. The cleaning process according to claim 1, wherein a voltage is applied to the element, and wherein the voltage is in the range of about 0V-−1.2V vs. an Ag/AgCl reference electrode.

7. The cleaning process according to claim 6, wherein the element is a contaminant barrier, such as a static contaminant barrier.

8. The cleaning process according to claim 6, wherein the element is a collector.

9. The cleaning process according to claim 6, wherein the element has a first part that contains relatively more deposition than a second part, and wherein the voltage applied to the element has a gradient over the element and wherein the element is arranged to have a larger voltage at the first part than at the second part.

10. The cleaning process according to claim 9, wherein the voltage at the first part is in the range of about −0.6V-−0.9V.

11. The cleaning process according to claim 6, wherein the voltage is in the range of about −0.7V-−1.0V.

12. The cleaning process according to claim 1, wherein the cleaning liquid further comprises a complexing agent.

13. The cleaning process according to claim 12, wherein the complexing agent comprises sodium gluconate.

14. The cleaning process according to claim 12, wherein the element is a collector.

15. The cleaning process according to claim 1, wherein the alkaline cleaning liquid has a pH in the range of about 8-15.

16. The cleaning process according to claim 1, wherein the alkaline cleaning liquid has a pH in the range of about 10-12.

17. The cleaning process according to claim 1, wherein the alkaline cleaning liquid has a temperature in the range of about 0-120° C.

18. The cleaning process according to claim 1, comprising treating the element with the alkaline cleaning liquid, washing the cleaned element, drying the element, and evaluating the element, optionally reintroducing the element in the cleaning process, and rearranging the element in the lithographic apparatus.

19. A cleaning system comprising a cleaning reactor, a washing reactor, a drying reactor and an evaluation system.

20. The cleaning system of claim 19, wherein the cleaning reactor is configured to treat an element of a lithographic apparatus with an alkaline cleaning liquid.

21. The cleaning system of claim 20, wherein the washing reactor is configured to wash the treated element and wherein the drying reactor is configured to dry the washed element.

22. The cleaning system of claim 21, wherein the evaluation system is configured to perform measurements on the dried element to determine whether the treated element is within pre-determined specification.

23. A combination of a lithographic apparatus and a cleaning system according to claim 19.

24. The combination according to claim 23, wherein the evaluation system comprises a vacuum qualification evaluation system.

25. The combination according to claim 23, wherein the lithographic apparatus comprises an illumination system configured to condition a radiation beam; a support constructed to support a patterning device, the patterning device being capable of imparting the radiation beam with a pattern in its cross-section to form a patterned radiation beam; a substrate table constructed to hold a substrate; and a projection system configured to project the patterned radiation beam onto a target portion of the substrate.

26. The combination according to claim 20, wherein the lithographic apparatus is an EUV lithographic apparatus.

27. A lithographic system comprising:
a lithographic apparatus including
an illumination system configured to condition a radiation beam;
a support constructed to support a patterning device, the patterning device being capable of imparting the radiation beam with a pattern in its cross-section to form a patterned radiation beam;
substrate table constructed to hold a substrate; and
a projection system configured to project the patterned radiation beam onto a target portion of the substrate; and
a cleaning system including a cleaning reactor configured to treat an element of the lithographic apparatus with an alkaline cleaning liquid.

28. The lithographic system according to claim 27, wherein the cleaning system comprises a washing reactor configured to wash the treated element and a drying reactor configured to dry the washed element.

29. The lithographic system according to claim 27, wherein the element is selected from the group consisting of a grating spectral filter, a transmissive optical filter, a multi-layer mirror, a grazing incidence collector, a normal incidence collector, a sensor, an optical sensor, a contaminant barrier, the patterning device and a construction element.
